(19) United States
(12) Patent Application Publication
(10) Pub. No.: US 2025/0182226 A1
(43) Pub. Date: Jun. 5, 2025

(54) A SYSTEM OF TRADEMARK RISK MANAGEMENT AND METHOD THEREOF

(71) Applicant: AIPLUX TECHNOLGY CO., LTD., Taipei City (TW)

(72) Inventors: PENG-CHUN WU, Taipei City (TW); EN-PING LU, Taipei City (TW); VINCENT CHEN, Taipei City (TW)

(21) Appl. No.: 18/842,731

(22) PCT Filed: Jan. 17, 2024
(86) PCT No.: PCT/US2024/011876

§ 371 Date: Aug. 29, 2024

Related U.S. Application Data
(60) Provisional application No. 63/439,324, filed on Jan. 17, 2023.

(51) Int. Cl. G06Q 50/18; G06Q 10/0635

(52) U.S. Cl. CPC G06Q 50/184; G06Q 10/0635

(57) ABSTRACT

The present invention provides a trademark risk management system and method, which is implemented by providing a user-operated electronic device, wherein the electronic device comprises a processor and a network interface controller, a server comprises an application, and the processor connects to the server through the network interface controller to execute the application for the purpose of category recommendation and risk management, especially for the regeneration of text or graphics.

### TECHNICAL FIELD

This invention relates to a trademark risk management system and its method, specifically for the regeneration of trademark text or graphics.

### BACKGROUND OF THE INVENTION

In the traditional patent application process, both domestically and internationally, it is necessary to print out paper documents and fill in numerous forms. Many documents are paper-based which causes great trouble in management and classification. It is not only environmentally unfriendly and wastes a lot of paper, but also a management oversight can lead to mistakes in the patent application process or patent invalidation, which is a serious loss. Besides the traditional paperwork, if communication between personnel is needed during the patent application process, due to their different professional backgrounds, language usages, cultural differences, and other unpredictable factors, information may be conveyed inaccurately or misunderstood. This leads to discrepancies in understanding between the applicants, offices, agents, and government agencies. Therefore, the applicants may not be able to achieve the results they originally wanted.

Furthermore, the purpose of applying for a patent is not merely to serve as a defensive weapon in patent infringement litigation, or as a symbol of a company's image. In fact, patent rights can create value. Apart from obtaining licensing income by allowing others to implement the patent, the right to exclude infringement and the right to damages can also yield settlement income.

For enterprises, using patent applications to protect research and development outcomes has long become a necessary and significant part of the business process. Some companies consider patent applications to be the job of professional patent firms. By inviting contractors to discuss the technical content of the patent application, a professional patent firm can draft a patent document with accurate technical descriptions, complete content disclosure, and broad protection scope.

In reality, patent application is not just a collaborative task between enterprises and patent firms, but also requires communication between different departments within the enterprise, especially repeated communication between the R&D department and the intellectual property rights department. During the internal patent proposal process within an enterprise, R&D engineers from the R&D department need to provide relevant technical content disclosures. This may comprise a basic background description of the technology, deficiencies of the existing technology or issues that need improvement, and the characteristics of the new technology. Additionally, a preliminary search in patent databases across multiple countries is required for the proposed technical content to identify similar prior art, facilitating internal patent proposal discussions. In many enterprises, the number of people in the R&D department far exceeds that of the internal intellectual property rights department, which increases the workload of the intellectual property rights department.

However, despite the fact that most medium and large enterprises have relevant patent proposal systems in place, in practice, due to the professional differences between the R&D department and the intellectual property rights department, there is a significant time cost in communication, ranging from a few days to several months. The R&D department is very familiar with the technology, but often fails to meet the requirements of the intellectual property rights department for the content needed for patent proposals (patent disclosures). Conversely, when the intellectual property rights department discusses with the R&D department based on previous technology search reports, they usually cannot detail the differences clearly enough for the R&D department to understand at a glance. Thus, the progress of internal patent proposal (patent disclosure) discussions consumes a considerable amount of labor and time. If the enterprise's internal production of the patent disclosure, including drawings and even claims, typically takes at least several days to weeks. Since most enterprises outsource to third-party patent and trademark offices or law firms to assist in drafting patent descriptions and submitting patent applications, without a patent disclosure, it is as if the R&D personnel are communicating the technology again, incurring more costs in communication and understanding, leading to delays in patent application time, affecting the enterprise's rights to technical protection.

Furthermore, for small and medium-sized enterprises and startups without an intellectual property rights department, patent searches are entirely entrusted to third-party patent and trademark offices or law firms for assistance. However, due to the absence of any patent proposal (patent disclosure), the process is mostly carried out through presentations or interviews. Such a model often results in inventors spending a great deal of effort and time on technical communication. Compared to medium and large enterprises, the communication and understanding costs in this process are even more astonishingly high.

However, there are now numerous search technologies and platforms available that help reduce the operational time for users.

As disclosed in Chinese application number CN201610297330.0, a patent drafting assistance system comprises: a disclosure template generation module, for generating a template used for drafting a technical disclosure document containing multiple fields; a disclosure input module, for correspondingly entering content into the multiple fields of the template to generate a technical disclosure document; a content identification and extraction module, for identifying and extracting content from each field of the technical disclosure document; a related search module, connected to an external database server, for selecting content extracted by the content identification and extraction module and associating it with the external database server to retrieve related information from the external database; a copy storage module, for copying and storing the retrieved data from the external database; and a document generation module, for generating a document in a predetermined format with the copied data.

However, the aforementioned Chinese application number CN201610297330.0 has several issues that need improvement. Its main feature is the modularization of text entered by the writer into corresponding fields, extracting keywords from the modularized text according to different fields, conducting searches for each keyword, and ultimately generating search data for the writer's reference. This reduces the time for manual keyword search input. The actual reduction in time for drafting documents, analyzing and comparing, or communication between different departments within an enterprise is quite limited, and it is only applicable to text, unable to assist in generating diagrams.

As disclosed in the Taiwanese application number TW097119308, there is a system for generating patent specifications, primarily comprising a method that can be implemented as software or an application. This invention pertains to a system capable of producing a written paper copy of a patent specification. The system comprises a central processing unit for executing computational processes of the patent specification generation method; a data storage unit connected to the central processing unit, storing the patent specification generation method for execution; an input unit connected to the central processing unit for providing an interface for users to input relevant technical disclosure data; a control unit connected to the central processing unit for controlling the processing of generating patent specification data; an output unit connected to the central processing unit serving as an interface for outputting patent specification data, which can be connected to a printing unit for printing the patent specification; and finally, a display unit connected to the central processing unit for displaying the outputted patent specification data.

However, the aforementioned Taiwanese application number TW097119308 has several issues that need improvement. It requires entering corresponding text into the respective fields. The method mainly involves the use of common terminologies in the patent specification, similar to filling in blanks to generate the specification text. However, the entered text must conform to preset specifications, otherwise, the generated sentences may not be grammatically correct, making it difficult for the average user to easily start using it. Essentially, the user must still invest a significant amount of time to generate the document themselves, and it does not solve the issue of communication documents for patent disclosures before the application. Moreover, it is limited to text and cannot assist in generating diagrams.

As disclosed in the U.S. application Ser. No. 17/745,671, in a specific embodiment, the assistance system can help users acquire information or services. The assistance system enables users to interact with it through various modes of input (such as audio, voice, text, image, video, gesture, motion, location, orientation) in stateful, multi-turn conversations to receive assistance from the system. As an example and not a limitation, the system can support single-mode input (like voice only), multi-mode input (like voice and text), hybrid/multi-mode input, or any combination of these. User input provided may be associated with specific assistant tasks and may comprise, for example, user requests (like a verbal request for information or execution of a motion), interaction with an assistant application associated with the assistant system (like selecting UI elements through touch or gesture), or any other type of suitable user input the assistant system can detect and understand (like user movement detected by the user's client device). The assistant system can create and store user profiles that comprise personal and contextual information associated with the user. In certain implementations, the assistance system can use Natural Language Understanding (NLU) to analyze user input. This analysis can be based on the user's profile to achieve a more personalized and context-aware understanding. The system can parse entities associated with user input based on the analysis. In certain implementations, the assistance system can interact with different agents to obtain information or services associated with the parsed entities. The assistance system can generate responses for the user about the information or services using Natural Language Generation (NLG).

However, there are several issues to be improved with the aforementioned U.S. application Ser. No. 17/745,671. The prior case utilizes Natural Language Understanding and Natural Language Generation to analyze user input text and generate corresponding reactive actions or responses, implemented through a ‘voice assistant’. But this is only applied in general daily life, and the language used or trained in the background data is quite different from intellectual property rights (patents and trademarks) legal terminology in both vocabulary and grammar. It is a horizontal training model, and if applied to the vertical industry of intellectual property rights, the accuracy would decrease significantly.

As revealed in the doctoral dissertation by Jie-Sheng Lee from the Graduate Institute of Computer Science and Engineering, National Taiwan University (Deep Learning Applications in the Patent Field 10.6342/NTU202100999), there are issues with the scale of the language model training being insufficient and the quantity of data being inadequate, potentially leading to inaccurate training results. Furthermore, the training does not deeply specialize in patent language. The method relies heavily on the accuracy of the input text to generate a summary, from which the technical content is derived. This can easily result in deviations in the technical content text. The comparison method used in the thesis is text mapping, which, despite its many advantages, such as capturing semantic information and contextual relations of the text, also has several drawbacks: (1) Dimensionality disaster: With very large text data, text mapping can lead to high-dimensional vector representations that pose challenges for computation and storage. (2) Semantic discrimination difficulty: Although text mapping can capture some semantic information, it may not fully reflect the semantics of polysemous or context-dependent words. The semantic similarity between different texts may also be problematic. (3) Training data requirements: Text mapping methods typically need a large amount of labeled training data to learn vector representations of words and texts. Acquiring large-scale, high-quality labeled data can be time-consuming and expensive. (4) Vocabulary maintenance: Text mapping methods map words to a vector space, but new vocabulary, spelling errors, or other word variants may be encountered in practical applications. This may require vocabulary maintenance and updates to ensure the accuracy of the model. Moreover, this thesis utilizes training with BERT and version 2.0, which has its limitations. It still does not solve the communication problem between inventors and patent professionals.

Moreover, the current Natural Language Processing (NLP) models developed by OpenAI, such as Chat GPT 3.5 and 4.0, are autoregressive language models trained using Reinforcement Learning from Human Feedback (RLHF). They are primarily used for handling customer service conversations, storytelling, translation, grammar editing, poetry, lyrics, text organization, and even writing software programs. However, when inventors use GPT for dialogue-based generation of patent disclosures, it cannot directly produce accurate patent industry content or generate related patent process diagrams. For inventors, it only serves as a chatbot for consulting on patent regulations. Furthermore, using GPT for patent-related searches will only yield correct patent certificate numbers and will not provide accurate case names and patent diagrams. Refer to FIGS. 1 and 2. For patent professionals, this requires repeated verification, which can be time-consuming. Therefore, there is a need for a deep learning model specialized in the vertical field of intellectual property rights and aimed at industry precision to assist in managing patent disclosures and patent searches to address this issue.

Similar to existing patent drafting tools like Patent Theory, PowerPatent, Rowan, etc., which can assist in the writing of patent documents, these tools, through the help of professional practitioners during the drafting process, offer essential assistance or editing functions. This helps to reduce the error rate in the completed patent descriptions, such as maintaining consistency in terminology, even providing writing suggestions, or generating content for reference. On the other hand, they also increase the efficiency of writing patent specifications.

However, the aforementioned existing tools still have several issues that need improvement. Mainly, these tools were developed for professional practitioners in the intellectual property rights industry. That is to say, the primary target users of these tools are engineers who already have some experience in writing patent specifications. These tools only serve as an auxiliary role. Therefore, for relatively inexperienced corporate enterprise R&D personnel, using these tools does not substantially help them solve problems. The operation of these tools is not intuitive enough for them, and these tools also cannot produce diagrams. For individuals or personnel from small and medium-sized enterprises who are not professional practitioners, these tools are incapable of generating technical disclosures and diagrams.

From the above descriptions, it is evident that there is a need to improve or adjust the known technology to enhance the convenience of trademark selection for R&D personnel. To avoid missing timely opportunities for urgent trademark applications, the inventor of this invention has made significant research and creative efforts and has finally developed the system and method of this invention.

### SUMMARY OF THE INVENTION

The objective of this invention is to propose a system and its execution method that solve the problems existing in the current technology.

Therefore, in order to achieve the objectives of this invention, the present invention provides a trademark risk management method that is implemented by providing an electronic device operated by a user. This electronic device comprises a processor and a network interface controller. There is a server that contains an application. The processor, through the network interface controller, connects to the server and executes the application to carry out the method of category recommendation and risk management, which comprises at least the following steps:
(S100) The user utilizes the user interface of the electronic device to make the processor execute an input module to enter text content.
(S200) The processor executes a semantic analysis module within the application to perform semantic analysis on the text content.
(S300) The semantic analysis module further connects to a classification module, a search module, and a database module, classifying the analyzed text content by industry technology and performing comparative searches within the database module, sending the matched data to an intellectual property information disclosure module;
(S400) The intellectual property information disclosure module analyzes and compiles the data and presents the information to the user through the user interface of the electronic device;
(S500) The analyzed and compiled data is also sent to a category recommendation module, which classifies and compiles the intellectual property rights in the data, ranks them, and displays the recommended types of intellectual property rights to apply for on the user interface;
(S600) The user selects the type of trademark through the user interface;
(S700) The user enters a brand description through the user interface, prompting the processor to execute the input module;
(S800) Login is completed through a login module, enabling the processor to execute the semantic analysis module and the search module to match the analysis results in the database module, generating a recommended trademark category;
(S900) The processor executes the search module to perform a second comparative search in the database module based on the recommended trademark category, and sends the second search results to a search document generation module, which produces a risk assessment report.

After step (S900) the process further comprises: (S901) A risk management module, based on the approximate text or graphics in the risk assessment report and the conceptual information from the user received by the input module, regenerates the text or graphics.

Another objective of this invention is to propose a system that solves the problems existing in the current technology.

Therefore, to achieve this other objective of the invention, it provides a trademark risk management system operated by a user through an electronic device. The device's processor connects to a server via a network interface controller and executes an application for category recommendation and risk management. The system comprises at least:

An input module to receive text content entered by the user, tag it, convert it into strings, send string information, and record the input language of the string information in temporary memory;

A semantic analysis module that receives the string information and conducts analysis and tokenization through a natural language database, generating and sending semantic analysis results;

A classification module that analyzes the semantic analysis results for industry category codes, connects to a database module to determine and generate at least one set of industry classification codes;

A search module that conducts comparative searches in a database module based on at least one set of industry classification codes and generates data for search results;

An intellectual property rights information disclosure module that receives the data, further conducts statistical analysis, and produces basic intellectual property rights information.

A recommendation module, which also receives the data and classifies and compiles the intellectual property rights within the data to generate recommended types of intellectual property rights for application; and

A login module, through which the user performs identity verification on the electronic device;

When the user selects a trademark from the recommended types of intellectual property rights, the input module receives the brand description input by the user a second time. After identity verification through the login module, the semantic analysis module receives string information about the brand description, analyzes it, and sends the results of the technical description analysis. The search module conducts a comparative search in the database module with the analysis results and sends the search results to the recommendation module to generate the recommended trademark category. The search module performs a second comparative search in the database module based on the recommended trademark category and sends the second search results to a search document generation module, which produces a risk assessment report.

Additionally, a risk management module is comprised, which regenerates text or graphics based on the approximate text or graphics in the risk assessment report and the conceptual information received from the user by the input module.

The following detailed explanation is only provided by specific embodiments and is further illustrated with diagrams.

### BRIEF DESCRIPTION OF THE DRAWINGS

FIG. 1 is a schematic of prior technology;

FIG. 2 is another schematic of prior technology;

FIG. 3 shows the flowchart of the method of this invention;

FIGS. 4 to 6 show schematics of the system of this invention;

FIG. 7 shows a schematic of another embodiment of this invention's system;

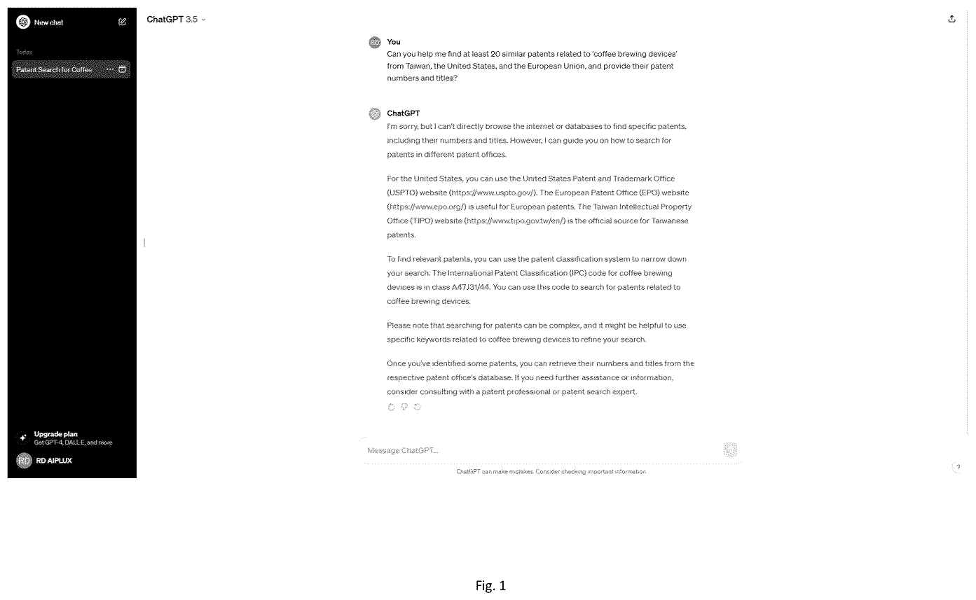

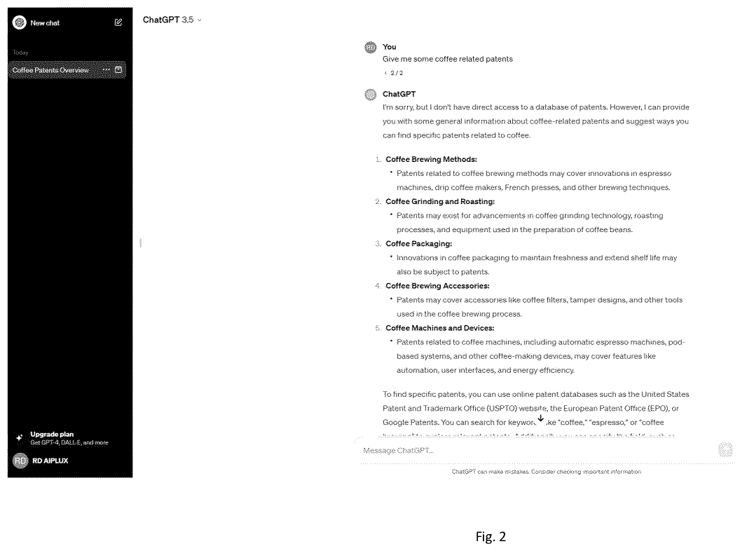

and FIGS. 8 to 10 show the flowcharts of the method of this invention.

### DETAILED DESCRIPTION OF THE DISCLOSURE

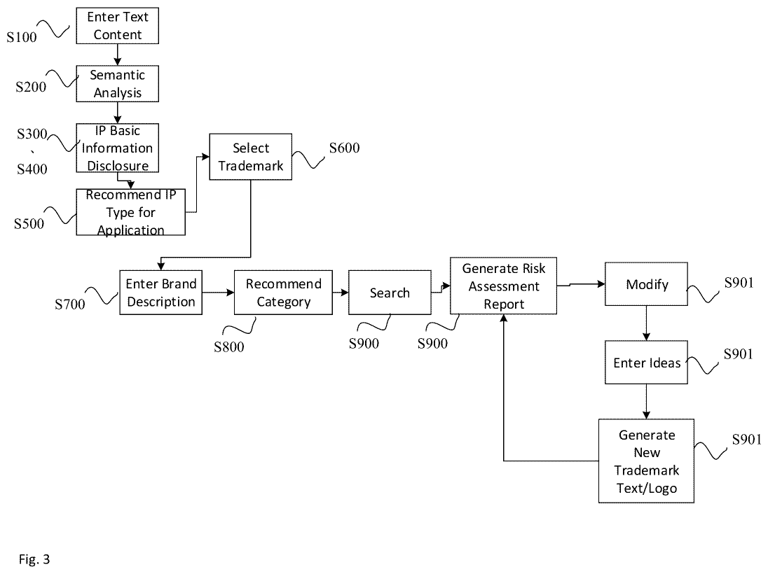

The present invention provides a trademark risk management system and method. Referring to FIG. 3, the method of the present invention is performed by a user operating an electronic device. The processor of the electronic device connects to a server via a network interface controller to execute an application for category recommendations and risk management. The method comprises at least the following steps:
(S100) The user uses the user interface of the electronic device to instruct the processor to execute an input module to enter text content;
(S200) The processor executes a semantic analysis module of the application to perform semantic analysis on the text content;
(S200) The processor executes a semantic analysis module of the application to perform semantic analysis on the text content;
(S300) The semantic analysis module further interfaces with a classification module, a search module, and a database module to classify the analyzed text content into industry technologies and perform a search in the database. The resulting data is sent to an intellectual property information disclosure module;
(S400) The intellectual property information disclosure module performs statistical analysis on the data and presents the information to the user through the user interface of the electronic device;
(S500) The analyzed and statistically processed data is also sent to a category recommendation module. The category recommendation module classifies and statistically analyzes the types of intellectual property in the data and displays recommended types of intellectual property for application in the user interface;
(S600) The user selects a trademark type through the user interface;
(S700) The user uses the user interface to instruct the processor to execute the input module to enter a brand description;
(S800) The user completes the login through a login module, and the processor executes the semantic analysis module. The search module performs a search in the database based on the analysis results, and the search results are sent to the recommendation module to generate recommended trademark categories; and
(S900) The processor executes the search module to perform a second search in the database based on the recommended trademark categories, and the results of the second search are sent to a document retrieval module to generate a risk assessment report.

After step (S900), it further comprises: (S901) a risk management module performs text or image re-generation based on approximate text or images in the risk assessment report and concept information from the user received by the input module.

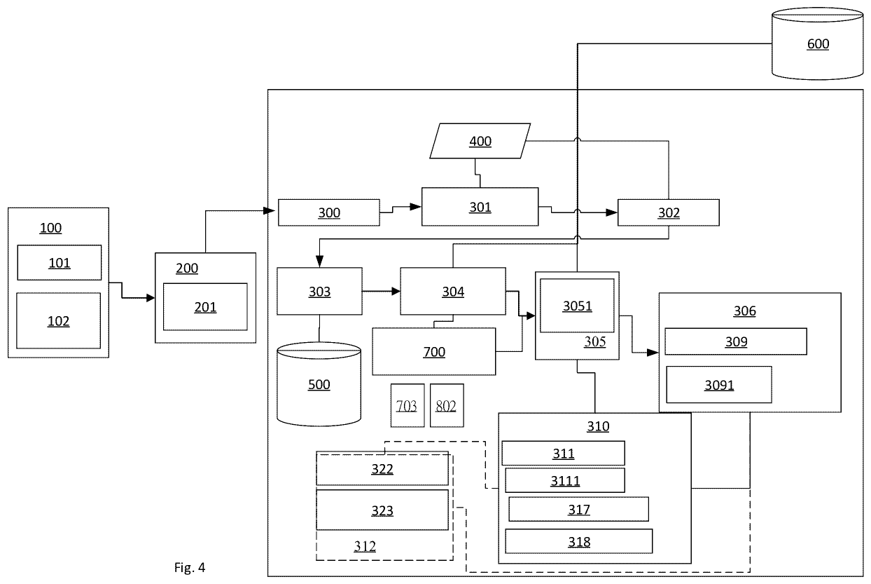

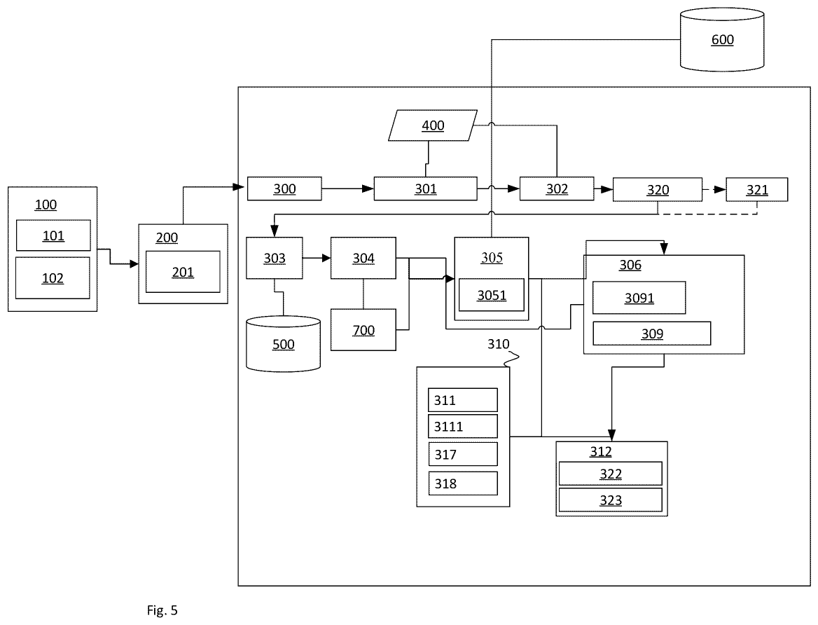

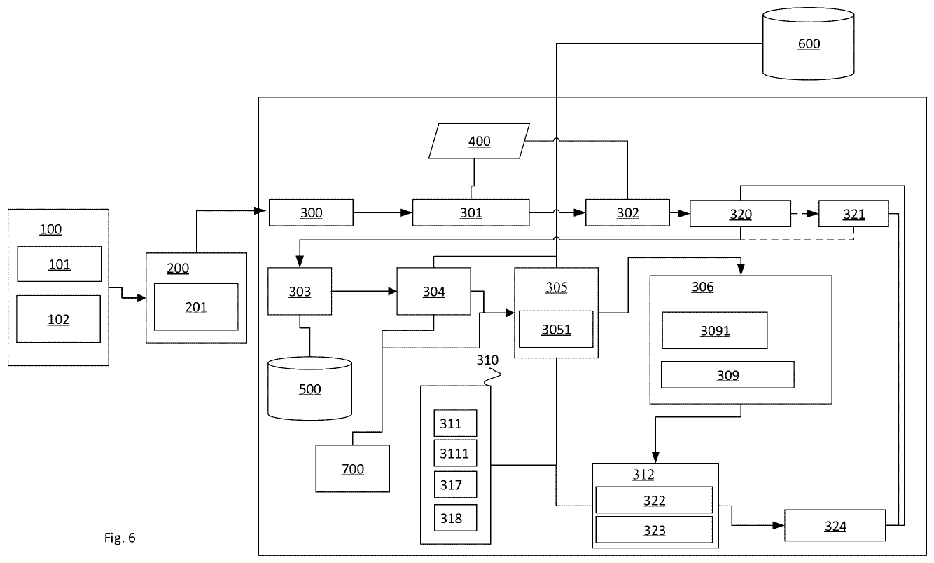

Please refer to FIGS. 4 to 6 for diagrams of the system of the present invention.

The system of the present invention is implemented by providing an electronic device 100 operated by the user. The electronic device 100 comprises a processor 101 and a network interface controller 102. A server 200 comprises an application 201. The processor 101 connects to the server 200 via the network interface controller 102 to execute the application 201 for category recommendations and risk management. The system comprises at least a login module 300, an order processing module 301, an input module 302, a semantic analysis module 303, a classification module 304, a content learning module 305, a risk management module 306, a diagram generation unit 309, a text generation unit 3091, a document retrieval module 310, a graphics retrieval unit 311, a text retrieval unit 3111, a database module 600, a natural language database 500, a recommendation module 802, a category recommendation module 700, and an intellectual property information disclosure module 703.

Among them, when the user selects the trademark as the type of intellectual property for recommendation in the recommendation application, the input module then receives the user's brand description input again and completes identity verification through the login module. Subsequently, the semantic analysis module receives string information about the brand description, conducts analysis and word segmentation to generate and send the analysis results of technical description. The search module then compares the analysis results in the database module and sends the search results to the recommendation module to generate trademark categories for the recommendation application. The search module, based on the trademark categories for the recommendation application, performs another comparison search in the database module and sends the results of the second search to a retrieval document generation module to generate a risk assessment report.

The risk management module regenerates text or graphics based on the approximate text or graphics from the risk assessment report and the conceptual information received from the user through the input module.

Specifically, a user can connect to the server 200 through the network interface controller 102 using an electronic device 100 and execute the application 201. They can input text or website links. The input text can be a description of a company's brand or a technical overview of the core products or services of a company's brand. They can also input the official website's URL link. By extracting and reading the content of the website, the semantic analysis module 303 can perform semantic analysis on the website's content and the input text, and then transmit the analysis results to the classification module 304.

The classification module 304 performs industry category code analysis on the semantic analysis results and connects to a database module to determine and generate at least one set of trademark classification codes.

Subsequently, the classification module uses at least one set of patent classification codes to connect to the database module 600 for comparative analysis. It compares the information such as the number of intellectual property applications and categories related to the same or similar industries in the database module 600. This comparison results in the generation of data on search results.

The Intellectual Property Information Disclosure module receives the data and conducts further statistical analysis to generate basic intellectual property information. This disclosed basic information may comprise details such as technology value, technical risk, intellectual property time cost, and expenditure cost, among others.

The present invention provides a trademark risk management system and method in which trademark names or graphics can be automatically regenerated based on creative or conceptual input from the inventor. Additionally, when the inventor publishes or inputs creative ideas, the system of the present invention can utilize Natural Language Processing (NLP) algorithms for artificial intelligence semantic reading, converting the input creativity into programming languages for regenerating graphics. Simultaneously, it conducts a search and comparison of graphics.

In one embodiment of the present invention, the focus is on describing the process where the user has already completed the intelligent recommendations and proceeds directly to category recommendations, risk assessment, and risk management. However, in this embodiment, the user can also start by receiving recommendations for intellectual property types before proceeding with category recommendations and risk management. Please refer to FIGS. 4 to 6 for a comprehensive understanding. The system of the present invention is implemented through an electronic device 100, which comprises a processor 101 and a network interface controller 102. A server 200 contains an application program 201. The processor 101 connects to the server 200 via the network interface controller 102 and executes the application program 201 for category recommendations and risk management. The system comprises at least a login module 300, an order processing module 301, an input module 302, a semantic analysis module 303, a classification module 304, a category recommendation module 700, a content learning module 305, a graphical learning unit 3051, a risk management module 306, a text generation unit 3091, a graphical generation unit 309, a document retrieval module 310, a text retrieval unit 3111, a graphical retrieval unit 311, a temporary memory 400, a database module 600, and a natural language database 500.

The server 200 can be a cloud server or a locally hosted server architecture.

In this embodiment, the creator utilizes a server with the following specifications for training and executing the trademark item transformation model of this technology: Processor 101 (CPU): A high-performance multi-core processor with a minimum of 16 cores or more, such as AMD Ryzen Threadripper or Intel Xeon series. This choice of CPU is particularly important for handling large volumes of data and performing complex calculations. Memory (RAM): The memory size can be 64 GB or higher to accommodate the size of the corpus data and word vector models. Network Interface Controller 102: It serves as high-speed and reliable network connectivity hardware, especially when used with cloud computing resources or for transferring large amounts of data. Graphics Processing Unit (GPU): An efficient GPU, such as NVIDIA's RTX 30 series or Tesla series, is employed to reduce the training time of the model. In this case, the training server used in the architecture of server 200 adopts the above higher specifications for training purposes. However, when model training is completed and inference processing is carried out, lower-specification server hosts can be used, whether in the cloud or on-premises. The choice of server host specifications does not impact the technical features emphasized in this case, and any server host specifications should still fall within the scope of this technology.

Login Module 300 allows users to authenticate their identity when operating electronic device 100. It ensures the confirmation of the user's identity and verifies their identity information simultaneously

Order Processing Module 301 provides users with functions such as member registration/login, the creation and management of international patent case orders, importation of international patent cases, and more. Additionally, it offers features for case order inquiries, patent and trademark examination status confirmation, and account inquiries.

Specifically, users can register and log in to become members of this system, enabling them to make patent applications and manage case orders on the platform. This comprises tasks such as document generation, case reception, submission of case copies, official document notifications, and more.

Users can create new case orders in the Order Processing Module 301. Once the user selects the first target country, the information from the case order is regularly updated in the system's temporary memory 400.

The Input Module 302 is responsible for receiving the descriptive text or graphics input by the user, particularly their creative concepts. It converts the descriptive text into strings for labeling and sends this string information. Additionally, it records the input language in the temporary memory 400.

The specific implementation can be described as follows: text preprocessing, label extraction, stringification, and label processing. Text preprocessing further comprises tokenization, stop word removal, part-of-speech tagging, and lemmatization. Label extraction initially uses predefined rules or patterns to extract labels and employs machine learning models for automatic label extraction. Stringification combines the extracted labels into a single string, such as “Movie#Action#Comedy.” Label processing can be performed based on specific requirements, including removing duplicate labels and sorting labels, among other operations. More specific approaches can utilize natural language processing (NLP) toolkits such as NLTK, Stanford NLP, HanLP, or machine learning frameworks like TensorFlow, PyTorch, and scikit-learn.

The semantic analysis module 303 receives string information and processes it through a natural language database 500 to perform analysis and tokenization. It then generates and sends the results of semantic analysis.

The classification module 304 analyzes the trademark category codes based on the results of semantic analysis. It connects to the database module 600 to determine and generate at least one set of trademark classification codes or trademark categories. This classification analysis can comprise internationally recognized trademark Nice Classification and/or trademark classifications specific to various countries, such as Taiwan's trademark classification.

To perform classification analysis and generate trademark categories for a piece of descriptive text, the following methods can be used:

Text Preprocessing: Firstly, preprocess the input descriptive text. This may involve removing punctuation, stop words, and meaningless characters, and performing lexical normalization (such as stemming or lemmatization).

Feature Extraction: Extract meaningful features from the preprocessed text. This can be done using common text feature representation methods such as Bag-of-Words or Word Embeddings. Bag-of-Words represents text as the frequency or presence of words, while Word Embeddings map words to a continuous vector space.

Trademark Classification Model: Build an industry classification model, which can be based on machine learning classifiers such as Support Vector Machines, Decision Trees, or deep learning models, or it can be based on rule-based methods. This model is trained to classify text into the corresponding industry categories.

Trademark Class Generation: Using the pre-trained classification model, classify the input descriptive text and generate the corresponding trademark classification code. The Nice classification is an international standard used for trademark classification.

Assuming we have a descriptive text as follows:

This company specializes in researching and developing new materials and technologies for solar power generation. They have designed an efficient solar cell that can convert solar energy into electricity while reducing energy costs and environmental impact. Their technology has great potential in the renewable energy sector and can be widely used for residential and industrial purposes.

We can perform trademark classification analysis and generate trademark classes using the following steps:

Text Preprocessing: Preprocess the descriptive text by removing punctuation, converting it to lowercase, and eliminating stopwords, and so on. For example, the above descriptive text can be preprocessed as follows: “company specializes researching developing solar power generation new materials technology designed efficient solar cell convert solar energy electricity reduce energy costs environmental impact technology renewable energy sector great potential widely used residential industrial purposes.

Feature Extraction: Utilize the bag-of-words model to transform the preprocessed text into a feature vector representation. Each word can be regarded as a feature, and the frequency of a word's appearance in the descriptive text can be used to signify its significance. For instance, the following feature vector representation can be obtained:

{“Company”: 1, “Specializes”: 1, “Researches”: 1, “Develops”: 1, “Solar Energy”: 2, “Power Generation”: 1, “New”: 1, “Materials”: 1, “Technology”: 2, “Designs”: 1, “High Efficiency”: 1, “Battery”: 1, “Conversion”: 1, “Electricity”: 1, “Reduces”: 1, “Energy”: 1, “Cost”: 1, “Environmental”: 1, “Impact”: 1, “Renewable Energy”: 1, “Potential”: 1, “Widely”: 1, “Applications”: 1, “Household”: 1, “Industrial”: 1, “Usage”: 1}.

Trademark Classification Model: Build a trained classification model, such as Support Vector Machine or deep learning models like Recurrent Neural Networks or Convolutional Neural Networks, using labeled training data with corresponding labels for model training.

Category Generation: Use the trained classification model to input the preprocessed text feature vector for prediction. Based on the prediction results, the corresponding trademark category can be generated. For example, the model may predict that the description text belongs to the solar energy-related industry category, and the corresponding Nice Classification may be categories 04, 09, 37, and 40, among others.

The category recommendation module 700 uses a computational model trained through natural language models and trademark classification tables and subcategories. It combines the semantic analysis module 303 and the classification module 304 to parse string information with ambiguous semantics (or imprecise descriptions) into trademark category recommendation information, ultimately generating recommended trademark categories for applications.

A natural language model is capable of predicting the next word or generating sentences that conform to grammar and semantics based on known text data. It can comprise, but is not limited to:

N-gram Model: The N-gram model is a probabilistic language model that assumes the probability of a word appearing is only dependent on the previous N−1 words. For example, in a bigram model (N=2), the probability of the next word is predicted based on the preceding word.

Recurrent Neural Network (RNN) Model: RNN is a type of neural network suitable for processing sequential data, allowing it to capture temporal dependencies between words. In natural language processing, RNNs are commonly used to construct language models, where each word is treated as a time step.

Pretrained Language Models (e.g., BERT): Pretrained language models are models that have been trained on a large-scale unsupervised dataset, enabling them to understand and generate natural language. The BERT model, based on the Transformer architecture, undergoes pretraining on extensive text data and is then fine-tuned for specific tasks such as text classification, named entity recognition, and more.

The trademark classification table and subcategories are extracted from trademark databases of various countries. This comprises all the goods and services categories listed within these classifications, which are extracted and organized into a list. This list is then used for training and computation by the natural language models.

The document retrieval module 310 comprises a text retrieval unit 3111, an image retrieval unit 311, a conversion unit 317, and an image matching unit 318. The image retrieval unit 311 receives the user's input image and searches in the database module 600, while the text retrieval unit 3111 receives the input text and searches in the same database module 600, resulting in retrieval documents.

Specifically, when the image retrieval unit 311 receives an input image, it first uses the conversion unit 317 to transform the image and add Vienna Classification labels. Simultaneously, the image is converted into a vector. Then, the image matching unit 318 compares it with the database module 600 and generates retrieval documents.

Converting an image into a vector, for example: Since images are essentially composed of pixels, with the brightest considered as 1 and the darkest as 0, let's assume we are not considering the three primary colors. For a 3×3 pixel image, we can arrange the pixels sequentially from the top-left, left-center, top-center, left-center, center-center, right-center . . . until the bottom-right as (1, 0, 1, 0, 1, 0, 1, 0, 1). In this case, the image is black-white-black-white-black-white-black-white-black. When considering the three primary colors, we simply extend this vector's length threefold, becoming R(1, 0, 1, 0, 1, 0, 1,0, 1)+G(1, 0, 1, 0, 1,0,1, 0, 1)+B(1, 0, 1, 0, 1, 0, 1, 0, 1)=(1, 0, 1, 0, 1, 0, 1, 0, 1, 1, 0, 1, 0, 1, 0, 1, 0, 1, 1, 0, 1, 0, 1, 0, 1, 0, 1). Then, by using the principle of local vector similarity =shape similarity, we can identify approximately matching images.

Specifically, during the matching process, you can calculate the degree of similarity in different ways, such as Edit Distance, Cosine Similarity, or Jaccard Similarity. Images with a similarity level exceeding a set threshold can be filtered out, and this threshold value can be adjusted as needed.

Edit Distance is commonly used to measure the similarity between strings. It quantifies the minimum number of operations (insertions, deletions, or replacements) required to transform one string into another. However, it can also be used to approximate the similarity between vectors.

Here are the general steps for calculating vector similarity using Edit Distance:

Vector Serialization: Convert each vector into a sequence. For example, digital vectors can be directly converted into digital sequences. Feature vectors can combine the names and values of each feature into a string sequence.

Calculate Edit Distance: Use an Edit Distance algorithm (such as Levenshtein distance) to calculate the Edit Distance between two sequences.

Normalization: Normalize the Edit Distance to have values in the range of 0 to 1 for ease of comparison. A common normalization method is dividing by the maximum length of the sequence.

Similarity: (1—Normalized Edit Distance), which indicates the similarity between two vectors. Typically, the closer the value is to 1, the more similar the vectors are.

For example, suppose you have two vectors: Vector 1=[1, 2, 3, 4], Vector 2=[2, 3, 1, 4].

Serialization: Vector 1->“1234”, Vector 2->“2314”

Edit Distance: 2 (requires two operations: swapping “1” and “3”)

Normalization: 2/4=0.5

Similarity: 1−0.5=0.5

Therefore, the similarity between these two vectors is 0.5, indicating a certain degree of similarity.

Cosine Similarity is a method for measuring the directional similarity between vectors and can be used to estimate the similarity between vectors. The principle is to calculate the cosine value of the angle between two vectors. The closer the angle is to 0, the more similar the vectors, and the closer the cosine value is to 1.

Here are the general steps for calculating vector similarity using Cosine Similarity:

Vector Preprocessing: Ensure that both vectors have the same dimensions; normalize the vectors (e.g., make their length 1) to eliminate the influence of differences in vector length.

Inner Product Calculation: Calculate the inner product between the two vectors, which involves multiplying corresponding elements pairwise and then summing them. The inner product reflects the directional correlation between the two vectors.

Vector Length Calculation: Calculate the length of each vector, which involves summing the squares of corresponding elements and then taking the square root. The vector length reflects its overall magnitude.

Cosine Similarity Calculation: Divide the inner product by the product of the lengths of the two vectors to obtain the cosine similarity between the two vectors.

Similarity Analysis: Cosine Similarity has a range of values from −1 to 1. When Cosine Similarity is close to 1, it indicates that the two vectors have a very similar direction, and the similarity is high. A Cosine Similarity of 0 means that the two vectors are orthogonal and completely dissimilar. When Cosine Similarity is close to −1, it indicates that the two vectors have opposite directions and are highly dissimilar.

Let's assume we have two vectors, Vector1=[2,3,4], and Vector2=[4,6,8].

Vector Preprocessing: These two vectors have the same dimensions, so no further processing is needed.

Inner Product Calculation: 24+36+4*8=62.

Vector Length Calculation: sqrt(2\hat{ }2+3\hat{ }2+4\hat{ }2)=sqrt(29), sqrt(4\hat{ }2+6\hat{ }2+8\hat{ }2)=sqrt(100).

Cosine Similarity Calculation: 62/(sqrt(29)*sqrt(100))≈0.906.

Therefore, the Cosine Similarity between these two vectors is close to 0.9, indicating a very high level of similarity in direction.

Jaccard Similarity is a method for measuring the similarity between vectors, and it can be used to estimate the similarity between vectors. The principle is to calculate the proportion of common elements between two vectors. A higher proportion indicates a higher similarity, resulting in a higher Jaccard Similarity.

Here are the general steps for calculating vector similarity using Jaccard Similarity:

Vector Preprocessing: Ensure that both vectors have the same dimensions. Normalize the vectors (e.g., make the sum of their elements equal to 1) to eliminate the influence of differences in vector length.

Calculate Intersection: Count the number of common elements between the two vectors.

Calculate Union: Count the total number of elements in both vectors.

Jaccard Similarity Calculation: Divide the intersection by the union to obtain the Jaccard Similarity between the two vectors.

Similarity Analysis: Jaccard Similarity has a range of values from 0 to 1. When Jaccard Similarity is close to 1, it indicates that the two vectors are identical, and the similarity is high. Jaccard Similarity of 0 means that the two vectors are completely dissimilar.

Let's assume we have two vectors, Vector1=[1,2,3,4], and Vector2=[1,3,4,5].

Vector Preprocessing: These two vectors have the same dimensions, so no further processing is needed.

Calculate Intersection: 1+3+4=8.

Calculate Union: 1+2+3+4+5=15.

Jaccard Similarity Calculation: 8/15≈0.533.

Therefore, the Jaccard Similarity between these two vectors is close to 0.5, indicating a certain degree of similarity.

Text Retrieval Unit 3111 receives the semantic analysis results from the semantic analysis module and performs matching analysis in the database module 600, such as similarity matching analysis of trademark names.

Retrieval Document Generation Module 310 combines the matching results from the image retrieval unit 311 and the text retrieval unit 3111 to generate retrieval documents and further sorts and filters the cases with similarity above a certain risk threshold to generate a risk assessment report.

Content Learning Module 305 is a large language model that learns the content of different trademarks from the database module 600 for different trademark categories. The image learning unit 3051 further learns the design of trademark graphics, such as graphic design, text design, unique words, etc., for different trademark categories.

Risk Management Module 306 generates text and/or graphics based on the learning from Content Learning Module 305 and the previous cases matched by Graphic Retrieval Unit 311 and Text Retrieval Unit 3111.

Database Module 600 provides multiple databases needed for multi-country trademark prior case retrieval in the system, such as official trademark databases from various countries, trademark class databases from multiple countries, or Nice Classification databases, etc.

Graphic Generation Unit 309 receives user input regarding modifications and concepts for trademark names or graphics through Input Module 302. Graphic Generation Unit combines Semantic Analysis Module to analyze the concepts and translates them into graphic generation language. It generates corresponding graphic code for the concepts and then compiles it to generate graphics that match the concepts. During the process of regenerating graphics, Graphic Retrieval Unit 311 performs similarity comparison against previously retrieved prior cases, ensuring that the similarity between the regenerated graphics and prior cases is below a predefined threshold.

Text Generation Unit 3091 receives user input regarding modifications and concepts for trademark names or graphics through Input Module 302. Text Generation Unit 3091 combines Semantic Analysis Module to analyze the concepts and then combines Content Learning Module to generate text, which is the trademark name. Simultaneously, Text Retrieval Unit 3111 performs similarity comparison against previously retrieved prior cases, ensuring that the similarity between the regenerated text and prior cases is below a predefined threshold.

Risk Management Module 306 combines the regenerated concepts to achieve the goal of reducing application risk. Users can choose whether to engage in risk management through the system after generating a risk assessment report. In other words, they can decide whether to regenerate text or graphics through the system to avoid text or graphics from prior cases.

Specifically, translating conceptual ideas into graphic language involves several steps. First, the translation module needs to analyze the extracted conceptual ideas to understand their meaning. Then, the translation module needs to generate a description in the graphic generation language based on the grammar rules of that language. More specifically, the following steps can be used to generate graphic generation language: identifying technical concepts, identifying technical features, and identifying technical relationships.

Identifying Technical Concepts: The translation module first identifies technical concepts in the technical information. Technical concepts are the basic elements in the graphic generation language.

Identifying Technical Features: The translation module then identifies technical features in the technical information. Technical features are used to describe technical concepts.

Identifying Technical Relationships: Finally, the translation module identifies technical relationships in the technical information. Technical relationships describe the connections between technical concepts.

In practice, the Semantic Analysis Module 303 can perform keyword extraction, which is a natural language processing technique aimed at automatically extracting important keywords or phrases from text. Methods for keyword extraction can comprise but are not limited to statistical methods, frequency-based methods, text vectorization methods, or machine learning methods.

Frequency-based methods determine the importance of words based on their frequency in the text. Common methods comprise TF-IDF (Term Frequency-Inverse Document Frequency) and Term Frequency. TF-IDF considers both the frequency of a word's occurrence in the text and its importance in the entire document collection, while Term Frequency only considers the frequency of a word's occurrence in the text.

Text statistical methods rely on statistical models to analyze the distribution and correlations of words in the text. Common methods comprise Mutual Information, Pointwise Mutual Information, and Chi-squared Test. These methods typically require the establishment of a statistical model between words and text and calculate the importance of words based on that model.

Text vectorization methods transform text into vector representations and then use the Vector Space Model to calculate the importance of words. Common methods comprise the Bag-of-Words Model, Word Embeddings, and text vectorization methods like TF-IDF vectorization.

Keyword Expansion is a further feature of keyword extraction. It receives generated keywords and extends them by finding similar or synonymous words, connecting them to a thesaurus to generate additional synonyms.

The system also comprises a Language Detection Module 320, which is used to determine whether the language of the string input by the user matches the official language of the first target country. If the Language Detection Module 320 determines that the string information does not match the official language of the first target country, a Translation Module 321 is used to translate the string information. After generating the retrieval document, the Translation Module 321 is again used to translate the language of the retrieval document back to the language of the original string information.

Furthermore, the system comprises a Case Processing Module 312, which executes the case orders of the system, generates them into compliant trademark application documents. The system also comprises a Cross-Border Conversion Module 324 that can perform cross-border conversion of trademark application documents, and even integrates system case orders with third-party electronic payment services.

The Case Processing Module 312 further comprises an Application Form Generation Unit 323. The Application Form Generation Unit 323 extracts user login authentication identity information and incorporates it into the application data, or the user can directly input the application data into the field through the electronic device 100, which is received by the input module 302. The application data is then generated into an application form by applying a formatting template.

After generating the application form, the user can operate the electronic device 100 to submit the application online or manage the case online through the Case Processing Module 312. Submission can be done either by the user directly submitting the application to the authorities or by choosing the submission function, which is then handled by the law firm providing the system, especially considering the different application document formats and file formats in different countries.

The system also comprises a Cross-Border Conversion Module 324. After generating the application form, the user can select a second target country using the Cross-Border Conversion Module 324 to apply for trademark protection in different countries.

After the user selects the second target country, the Language Detection Module 320 first determines whether the language of the string information matches the official language of the second target country. If they are not the same, the Translation Module 321 is used to translate the trademark name into the official language of the second target country. Then, the application form is translated into the official language of the second target country, followed by formatting adjustments.

Alternatively, the Language Detection Module 320 can first determine whether the language of the application form matches the official language of the second target country. If they match, the instruction document and application form are directly adjusted in accordance with the official document format of the second target country. If they do not match, the Translation Module 321 is used to translate the application form into the official language of the second target country, followed by formatting adjustments.

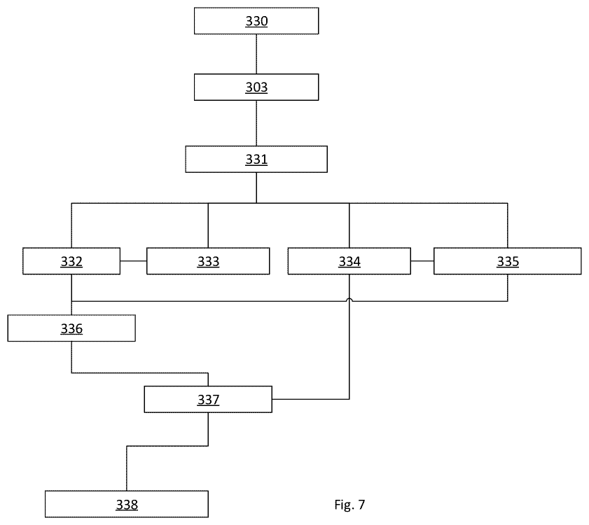

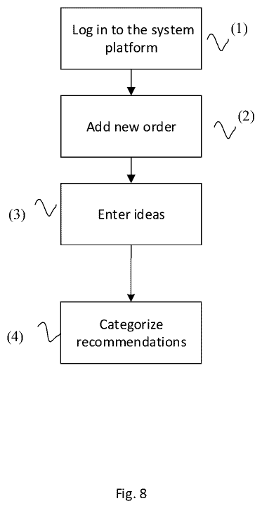

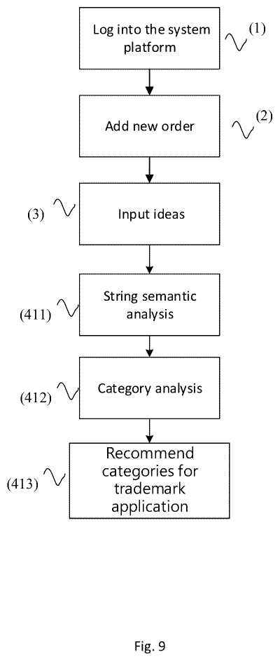

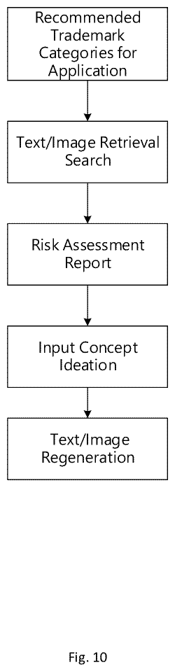

In another embodiment of the present invention, please refer to FIG. 4 and FIG. 7. FIG. 7 illustrates another schematic diagram of the system of the present invention, including: Data Reception Module 330, Semantic Analysis Module 303, Keyword Extraction Module 331, Search Module 332, Classification Analysis Module 333, Text Generation Module 334, Content Learning Module 305, Keyword Expansion Module 335, Document Classification Module 336, Automatic Writing Module 337, and Retrieval Report Generation Module 338.

The Data Reception Module 330 can comprise Login Module 300, Order Processing Module 301, and Input Module 302. The Login Module 300 allows users to perform identity verification through the electronic device 100, confirming the user's (login user) identity and simultaneously confirming identity information. The Order Processing Module 301 provides users with functions such as member registration/login, multi-country trademark case order creation and management, multi-country trademark case import, and can further provide functions such as case order inquiry, trademark review status confirmation, and account inquiry. The Input Module 302 is used to receive the descriptive text or graphics input by the user, convert the descriptive text into a string for labeling processing, send the string information, and record the input language of the string information in the temporary memory 400.

The Semantic Analysis Module 303 receives string information, analyzes and tokenizes it through a natural language database 500, and generates and sends semantic analysis results.

The Keyword Extraction Module 331 performs word segmentation and keyword extraction based on the input content, generating multiple keywords.

Specifically, Keyword Extraction is a natural language processing technique aimed at automatically extracting important keywords or phrases from text. Methods can comprise but are not limited to statistical methods, frequency-based methods, statistical methods, text vectorization methods, or machine learning methods.

Frequency-based methods, such as Term Frequency-Inverse Document Frequency (TF-IDF) and Term Frequency (TF), determine the importance of words based on their frequency in the text. TF-IDF considers both the frequency of a word's occurrence in the text and its importance in the entire document collection, while TF only considers the frequency of a word's occurrence in the text.

Statistical methods in text analysis are based on statistical models that analyze the distribution and relationships of words in the text. Common methods comprise Mutual Information, Pointwise Mutual Information (PMI), and Chi-squared Test. These methods typically require the establishment of a statistical model between words and text and calculate the importance of words based on this model.

Text vectorization methods convert text into vector representations and use Vector Space Models (VSM) to calculate the importance of words. Common methods comprise the Bag-of-Words Model (BoW), Word Embeddings, and text vectorization methods like TF-IDF vectorization.

Machine learning methods use machine learning algorithms to train models that learn the importance of words from the text. Common methods comprise text classification, text clustering, and keyword extraction models. These methods require the use of labeled text data for model training.

The above methods can also be implemented by writing a script in a programming language like Python.

The Search Module 332 comprises Text Retrieval Unit 3111, Image Retrieval Unit 311, Transformation Unit 317, and Image Matching Unit 318. The Image Retrieval Unit 311 receives the user's input image and searches in the database module 600, retrieving matching trademark cases. Upon receiving the input image, the Image Retrieval Unit 311 first transforms the image through the Transformation Unit 317, adding Vienna Classification labels and converting the image into a vector. Then, the Image Matching Unit 318 performs a comparison based on the database module 600, retrieving matching trademark cases. Furthermore, it extracts previous cases with similarity scores above a certain risk threshold.

The Classification Analysis Module 333 can be used by the Classification Module 304 to analyze industry category codes for the input text. It connects to the Database Module 600 to determine and generate at least one set of trademark classification codes, which can also be trademark class categories.

The Text Generation Module 334 can comprise the Risk Management Module 306, the Retrieval Document Generation Module 310, and can even further comprise Text Generation Unit 3091 and Image Generation Unit 309. The Retrieval Document Generation Module 310 can be part of the previously mentioned Search Module 332.

The Risk Management Module 306 receives concept ideas and generates text and/or images based on the semantic analysis results combined with the Content Learning Module 305.

The Keyword Extension Module 335 receives keywords generated by the Keyword Extraction Module 331 and extends them, meaning it finds similar words or synonyms by comparing them to a vocabulary to produce additional synonyms.

The Document Classification Module 336 can classify all case files created by the user, for example, by applying specific classification labels. It categorizes the created cases as disclosure documents or retrieval documents, and as patents or trademarks, among others.

Furthermore, the Document Classification Module 336 can also classify approximate images retrieved by the Image Retrieval Unit 311 in the Database Module 600. It categorizes these approximate images based on their similarity level. For example, images with similarity scores above the first risk threshold are classified into the high-risk area, those between the first and second risk thresholds are classified into the medium-risk area, and those below the second risk threshold are classified into the low-risk area.

The Automatic Writing Module 337 can integrate with the Risk Management Module 306 and the Content Learning Module 305 to automatically write and generate application documents.

The Retrieval Report Generation Module 338 can also be alternatively replaced by the Retrieval Document Generation Module 310, the Disclosure Document Generation Unit 307, the Claims Content Generation Unit 308, or the Image Generation Unit 309, as mentioned earlier.

Please refer to FIGS. 8 to 10 for the flowchart of the execution method examples of this system. A user operates an electronic device 100, and the processor 101 of the electronic device 100 connects to a server 200 through a network interface controller to execute an application 201 for recommending categories and risks, including at least:
(1) The user logs in through the electronic device 100, undergoes identity verification, and confirms user identity and user data.
(2) The user creates a case order through the electronic device 100 and selects the first target country. Information within the case order is regularly updated to the temporary memory 400.
(3) The user inputs descriptive text or graphics through the electronic device 100, converts the descriptive text into strings, and performs labeling to form string information. The input language of the string information is recorded in the temporary memory 400.
(4) The semantic analysis module performs semantic analysis on the string information, and the classification module classifies the string information into trademark categories.

In step (4), it further comprises:
(411) Analyzing and segmenting the string information through the semantic analysis module to generate semantic analysis results.
(412) Generating at least one set of trademark classification codes based on the semantic analysis results through the classification module 304.
(413) The category recommendation module 700 combines the semantic analysis module 303 and the classification module 304 to parse string information with fuzzy semantics (or imprecise descriptions) into trademark category recommendation information, ultimately generating recommended trademark categories.

In step (3), it further comprises:
(31) The language determination module determines whether the input language of the string information is the same as the official language of the first target country.
(32) If yes, semantic analysis is performed directly.
(33) If not, the string information is first translated into the official language of the first target country through the translation module, and then semantic analysis is performed. After step (413), the recommended trademark categories generated are translated back into the input language of the string information.

After step (413), it further comprises:
(421) The image retrieval unit and the text retrieval unit 3111 receive the text and/or images input by the user and search in the database module 600, comparing to retrieve trademark precedents and generate retrieval documents. High-similarity precedents are further filtered out.
(422) The image retrieval unit receives the input image, first transforms it through the transformation unit, adds Vienna classification labels, and transforms the image into a vector.
(423) Then, through the image matching unit, it compares the input image with precedents in the database module, selecting images with similarity scores exceeding a predetermined value as trademark precedents. The text retrieval unit 3111 uses a similar method for text matching.
(5) The risk management module 306 generates text and/or images based on the learning of the content learning module 305 and based on precedents matched by the image retrieval unit 311 and text retrieval unit 3111 in the database module 600.

Furthermore, it may comprise:
(51) The user inputs conceptual ideas for trademark names or graphics through the input module 302, and the image generation unit 309, combined with the semantic analysis module, analyzes the conceptual ideas and translates them into image generation language. It generates corresponding image code for the conceptual ideas and then generates images corresponding to the conceptual ideas through the compilation unit. During the image generation process, the image retrieval unit 311 compares the generated images with previously retrieved precedents to ensure the similarity of the generated images is below a predetermined value.
(52) The text generation unit 3091, combined with the semantic analysis module, analyzes conceptual ideas and generates text, which is the trademark name. It also compares the generated text with previously retrieved precedents using the text retrieval unit 3111 to ensure the similarity of the generated text is below a predetermined value.
(6) The application document generation unit extracts the user's login authentication identity data to become application data or allows the user to directly enter application data in the fields to generate the application document.

After generation, the case order can be completed, and the patent can be submitted for application.

Furthermore, after step (6), it further comprises:
(7) The user selects a second target country.
(71) The language determination module determines whether the language of the application document is the same as the official language of the second target country.
(72) If not, the application document is first translated into the official language of the second target country through the translation module, and then the application document generation unit adjusts the format of the translated specification document and the application document.
(73) If yes, the format is adjusted directly. After format adjustment, the cross-border patent application conversion is completed, and the application is submitted to the official of the second target country through the law firm.

Once the formatting adjustments are completed, the cross-border patent application conversion is finalized, and the application is submitted within the system. It is then handed over to a law firm for official submission to the authorities of the second target country.

Finally, the technical features and achievable technical effects of the present invention are summarized as follows:

First, with a trademark risk management system and method according to the present invention, it addresses the common difficulty people face in understanding the field of intellectual property rights, especially those who have no concept of which type of intellectual property rights to protect their own technology, by providing intelligent recommendations.

Second, with a trademark risk management system and method according to the present invention, it provides a quick recommendation and risk system and method for those who still find it difficult to determine which categories to apply for even after deciding on the type of intellectual property rights, saving more time and cost.

Third, with a trademark risk management system and method according to the present invention, it addresses the pattern of small and medium-sized enterprises and startups without an intellectual property department, reducing the effort and time spent on brand communication, as well as the communication and understanding costs during the process, thus avoiding the scenario of having no proposals.

Fourth, with a trademark risk management system and method according to the present invention, it provides a complete system and execution method from the early stages of technology branding, recommending the type of intellectual property protection, and ultimately generating recommended categories and risks. This significantly reduces the professional threshold for individuals to apply for intellectual property protection for their own specialized technology.

What is claimed is:

1. A trademark risk management method, wherein a user operates an electronic device, the processor of the electronic device connects to a server via a network interface controller and executes an application program to perform category recommendation and risk management, comprising the following steps:
(S100) The user inputs text content through the user interface of the electronic device, and the processor executes an input module to input the text content;
(S200) The processor executes a semantic analysis module in the application program to analyze the text content;
(S300) The semantic analysis module further connects a classification module, a search module, and a database module to classify the text content by industry technology and conduct a matching search in the database module, the matching data is then sent to an intellectual property information disclosure module;
(S400) The intellectual property information disclosure module analyzes and summarizes the data and presents the information to the user through the user interface of the electronic device;
(S500) The analyzed and summarized data is also sent to a category recommendation module, the category recommendation module classifies and summarizes the types of intellectual property in the data, and displays the recommended types of intellectual property for application in a ranked order on the user interface;
(S600) The user selects a trademark type through the user interface;
(S700) The user inputs brand description through the user interface, and the processor executes the input module to input the brand description;
(S800) The user completes the login process through a login module, and the processor executes the semantic analysis module, the search module conducts a matching search on the analysis results in the database module, and the search results are sent to the recommendation module to generate the recommended application trademark category;
(S900) The processor executes the search module to conduct a second matching search in the database module based on the recommended application trademark category, the second search results are sent to a search document generation module to generate a risk assessment report.

2. The method according to claim 1, wherein further comprises the following step after step (S900):
(S901) A risk management module regenerates text or graphics based on the similar text or graphics in the risk assessment report and the concept information of the user's brainstorm received by the input module.

3. A trademark risk management system for receiving a user end that receives a user through operating an electronic device, the processor of the electronic device connects to a server via a network interface controller and executes an application program for category recommendation and risk management, the system at least comprises:
an input module for receiving the text content input by the user, converting the text content to a string for labeling processing, and sending a string information and recording the input language of the string information in a temporary memory;
a semantic analysis module that receives the string information and analyzes and segments it through a natural language database to generate and send semantic analysis results;
a classification module that analyzes the industry category classification code for the semantic analysis results, connects to a database module to judge and generate at least one set of industry classification codes;
a search module that conducts a matching search in the database module based on the at least one set of industry classification codes and generates data of the matching search results;
an intellectual property information disclosure module that receives the data and further analyzes it statistically to generate basic intellectual property information;
a recommendation module that also receives the data and classifies and summarizes the types of intellectual property in the data to generate the types of intellectual property recommended for application; and
a login module through which the user operates the electronic device to authenticate the identity;
wherein, when the user selects a trademark from the types of intellectual property recommended for application, the input module receives the brand description input by the user again, and completes the identity verification through the login module, and the semantic analysis module receives the string information about the brand description, analyzes and segments it to generate and send the analysis results of the technical description, the search module conducts a matching search on the analysis results in the database module, and transmits the search results to the recommendation module to generate the recommended application trademark category, the search module conducts a second matching search in the database module based on the recommended application trademark category, and transmits the second search results to a search document generation module to generate a risk assessment report.

4. The system according to claim 1, wherein further comprises a risk management module that regenerates text or graphics based on the similar text or graphics in the risk assessment report and the concept information of the user's brainstorm received by the input module.

5. A trademark risk management system for receiving a user end that receives a user through operating an electronic device, the processor of the electronic device connects to a server via a network interface controller and executes an application program for category recommendation and risk management, the system at least comprises:
a login module through which the user operates the electronic device to authenticate the identity;
an order processing module that generates a new case order and regularly updates the information in the case order to a temporary memory of the system after the user selects the first target country;
an input module for receiving the description text or graphics input by the user, converting the description text to a string for labeling processing, and sending a string information and recording the input language of the string information in the temporary memory;
a semantic analysis module that receives the string information, analyzes and segments it through a natural language database, and generates and sends semantic analysis results;
a classification module that analyzes the trademark category classification code for the semantic analysis results, connects to a database module to judge and generate at least one set of trademark classification codes;
a category recommendation module that is a computational model trained with a natural language model and trademark classification tables and details, combined with the semantic analysis module and the classification module to parse the string information with ambiguous semantics or imprecise descriptions into trademark category recommendation information, and finally generates the recommended application trademark category;
a search document generation module that comprises a text search unit, a figure search unit, a conversion unit, and a figure comparison unit, the figure search unit receives the input figure and searches for the previous case in the database module, the text search unit receives the input text and searches for the previous case in the database module, and further ranks the similarity to generate a risk assessment report;
a content learning module that is a large language model, further including a pattern learning unit, which learns the corresponding trademark content from the database module for different trademark categories;
a risk management module that further comprises a text generation unit and a pattern generation unit, regenerates text and/or figures based on the learning of the content learning module and based on the previous cases matched by the figure search unit and the text search unit in the database module;
wherein, after the user inputs the brainstorming concept for the trademark name or figure through the input module, the pattern generation unit combines the semantic analysis module to analyze the brainstorming concept and translate it into pattern generation language, generate the pattern code corresponding to the brainstorming concept through the pattern generation language, and then generate the regenerated figure corresponding to the brainstorming concept through a compiler unit, and during the regeneration of the figure, the figure search unit will compare the similarity with the previous cases that have been searched, so that the similarity of the regenerated figure to the previous case is below a set value;
wherein, after the user inputs the brainstorming concept for the trademark name or figure through the input module, the text generation unit combines the semantic analysis module to analyze the brainstorming concept, and then regenerates the text by combining the content learning module, and at the same time, the text search unit compares the similarity with the previous cases that have been searched, so that the similarity of the regenerated text to the previous case is within the set value.

6. The system according to claim 5, wherein the figure search unit, upon receiving the input figure, first converts the figure into vector representation through a conversion unit, and then conducts a matching search in the database module through the figure comparison unit to find the previous case.

7. The system according to claim 5, wherein further comprises a language judgment module that determines whether the input language of the string information is the same as the official language of the first target country.

8. The system according to claim 7, wherein if the language judgment module determines that the input language of the string information is not the same as the official language of the first target country, the string information is translated using a translation module, in addition, the language of the trademark image in the final search document is translated back to the input language of the string information using the translation module.

9. The system according to claim 5, wherein further comprises a case processing module that further comprises:
an application form generation unit that extracts the identity information of the user authenticated by the login authentication and brings it into the application data, or the user directly inputs the application data in the fields through the electronic device and the input module receives the application data, and the application data is generated by applying the formatting template;
wherein, after the case processing module generates the application form, the user's case order is completed.

10. The system according to claim 5, wherein the conversion unit converts the figure from pixels to vectors.

11. The system according to claim 10, wherein the figure comparison unit uses edit distance, cosine similarity, or Jaccard similarity to calculate the similarity during the comparison process, and filters out the figures with a similarity exceeding a set value.

12. The system according to claim 5, wherein further comprises a keyword extraction module that extracts keywords from the input content, generates multiple keywords, and uses the keywords to train the model using machine learning algorithms.

13. The system according to claim 8, wherein further comprises a cross-country conversion module, after the user selects a second target country, the language judgment module first determines whether the input language of the string information is the same as the official language of the second target country, if not, the translation module is used to translate the trademark name to the official language of the second target country before formatting.

14. A trademark risk management method, comprising the following steps:
(1) The user logs in to the electronic device and authenticates the user's identity and identity information;
(2) The user creates a case order through the electronic device and selects the first target country, the information in the case order is updated to a temporary memory on a regular basis;
(3) The user inputs the description text or image through the input module of the electronic device, converts the description text into a string, and performs labeling processing to form string information, the input language of the string information is recorded in the temporary memory;
(4) A semantic analysis module performs semantic analysis on the string information, and a classification module performs trademark classification on the string information; in step 4, the following steps are further comprised:
(411) The semantic analysis module analyzes and segments the string information to generate semantic analysis results;
(412) The classification module classifies the string information based on the semantic analysis results to generate at least one set of trademark classification codes;
(413) The category recommendation module combines the semantic analysis module and the classification module to parse the string information into trademark category recommendation information, and finally generates the recommended application trademark category;
(421) The figure search unit and the text search unit receive the user's input text and/or image and search in the database module to compare and search for trademark precedents, generate a search file, and further filter out precedents with a similarity higher than a risk value;
In step 421, the following step is further comprised:
(5) The risk management module regenerates the text and/or image based on the learning of the content learning module and based on the precedents matched by the figure search unit and the text search unit in the database module.

15. The method according to claim 14, wherein further comprises the following steps in step (3):
(31) The language judgment module determines whether the input language of the string information is the same as the official language of the first target country;
(32) If yes, the semantic analysis is performed directly;
(33) If no, the string information is first translated to the official language of the first target country by a translation module, and then the semantic analysis is performed, in step (413), the generated recommended application trademark category is translated back to the input language of the string information.

16. The method according to claim 14, wherein further comprises the following steps after step (421):
(422) The figure search unit converts the input figure into a vector representation after receiving the input figure;
(423) The figure comparison unit then compares the figure in the database module and filters out the figures with a similarity exceeding a set value, the filtered figures are considered to be trademark precedents.

17. The method according to claim 14, wherein further comprises the following steps in step (5):
(51) After the user inputs the brainstorming concept for the trademark name or image through the input module, the pattern generation unit combines the semantic analysis module to analyze the brainstorming concept and translate it into pattern generation language, the pattern generation language is used to generate the pattern code corresponding to the brainstorming concept, the pattern code is then compiled by the compiler unit to generate the regenerated pattern corresponding to the brainstorming concept, during the regeneration process of the pattern, the figure search unit compares the regenerated pattern with the precedents that have been searched out, this ensures that the regenerated pattern has a similarity with the precedents that is below a set value;
(52) The text generation unit combines the semantic analysis module to analyze the brainstorming concept, and then regenerates the text based on the content learning module, the text generation unit also compares the regenerated text with the precedents that have been searched out, this ensures that the regenerated text has a similarity with the precedents that is below a set value.
